(19) United States
(12) Patent Application Publication
(10) Pub. No.: US 2011/0204818 A1
(43) Pub. Date: Aug. 25, 2011

(54) Portable Lighting Device and Related Method of Operation

(75) Inventor: David A. Spartano, Brunswick, OH (US)

(73) Assignee: EVEREADY BATTERY COMPANY, INC., St. Louis, MO (US)

(21) Appl. No.: 13/047,887

(22) Filed: Mar. 15, 2011

Related U.S. Application Data
(63) Continuation of application No. PCT/US08/11407, filed on Oct. 2, 2008.

(51) Int. Cl. H05B 37/02

(52) U.S. Cl. 315/294; 315/291

(57) ABSTRACT

A portable lighting device and related method of operation is provided which includes a light source, a switch, a brightness control element, a display, a contact for receiving power, and a light source controller. The light source is illuminated by switch being moved to a first position at which light source controller supplies power to light source from power received through contact. Once power is on, brightness control element is used to adjust the brightness of light source. Brightness control element may be a ring having multiple predetermined brightness settings disposed thereon with a detent and visual indicia associated with each setting. The display displays one or more usage parameters associated with the operation of the device such as brightness, lumen output, power consumption, and remaining power available at the current brightness setting.

### RELATED APPLICATIONS

This application is a continuation of International PCT Application No. US2008/011407, filed Oc. 2, 2008, the entire content of which is hereby incorporated by reference.

### FIELD OF THE INVENTION

The present invention generally relates to portable lighting devices, and more particularly, to portable lighting devices with adjustable brightness and a related method of operation.

### BACKGROUND OF THE INVENTION

Portable lighting devices, such as flashlights, are known in the art. Conventionally, such devices often are tubularly shaped and include a two position switch to turn the lamp on and off. Unfortunately, with such a device the brightness level cannot be varied.

Some flashlights include variable brightness control mechanisms. However, such mechanisms are often limited in that they generally only allow the operator to vary the brightness about a default initial brightness level while the flashlight is turned on.

### SUMMARY OF THE INVENTION

In an embodiment of the invention, there is provided a lighting device comprising, a light source; a body supporting the light source; a contact for receiving power for energizing the light source; a brightness control element movable between at least a first position and a second position; a controller in electrical communication with the brightness control element and configured to adjust an amount of power supplied to the light source based on the position of the brightness control element; and a display operatively connected to the controller for displaying one or more usage parameters associated with the power source and the light source.

In an embodiment of the invention, there is provided a method of operating a lighting device. The method comprises energizing a light source with power received through a contact; moving a brightness control element between at least a first position and a second position; adjusting with a controller in electrical communication with the brightness control element an amount of power based on the position of the brightness control element; and displaying on a display operatively connected to the controller one or more usage parameters associated with the power source and the light source.

In an embodiment of the invention, there is provided a method of operating a lighting device. The method comprises energizing a light source with power supplied from a power source received through a contact; displaying on a display one or more usage parameters associated with the power source and the light source; moving a brightness control element between at least a first position and a second position based upon the one or more usage parameters displayed on the display; and adjusting with a controller in electrical communication with the brightness control element an amount of power supplied by the power source to the light source based on the position of the brightness control element.

### BRIEF DESCRIPTION OF THE DRAWINGS

These and other features of the portable lighting devices with adjustable brightness will be more readily understood from the following detailed description of the various aspects of the embodiments taken in conjunction with the accompanying drawings in which:

FIG. 1 is a block diagram of a portable lighting device according to an embodiment of the invention.

FIG. 2 is a side view of a portable lighting device having adjustable brightness according to an embodiment of the invention.

FIG. 3 is a side view of a portable lighting device having adjustable brightness according to an embodiment of the invention.

FIG. 4 is a side view of a portable lighting device having adjustable brightness according to an embodiment of the invention.

FIG. 5 is a perspective view of a portable lighting device having adjustable brightness according to an embodiment of the invention.

FIG. 6 is a block diagram of a circuit for use with the embodiments of the portable lighting device of FIGS. 1-5.

FIG. 7 is a flow diagram of a method of operation of the embodiments of the portable lighting device of FIGS. 1-5.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

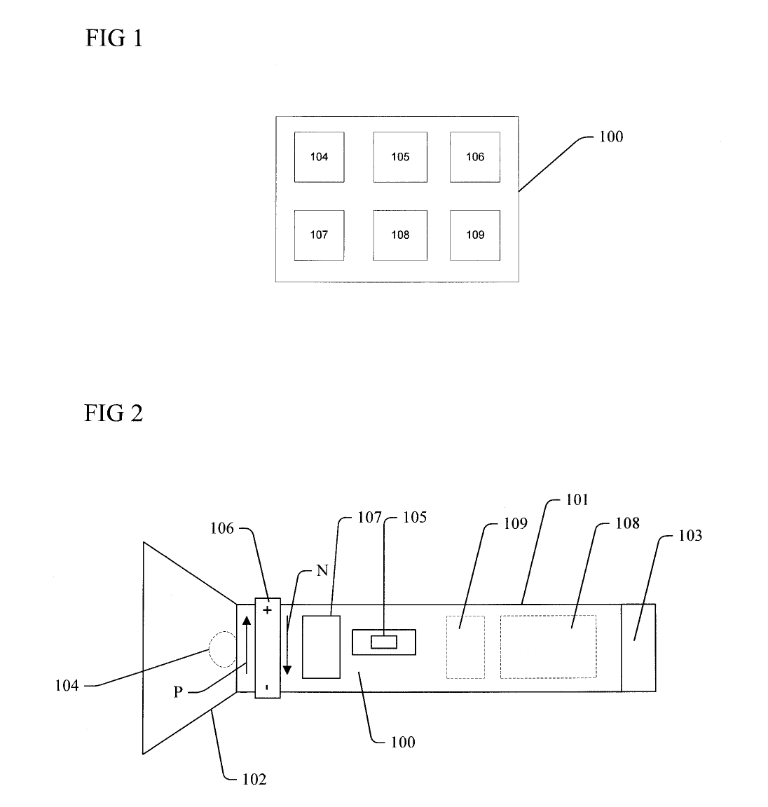

FIG. 1 shows a block diagram of a portable lighting device 100 such as a flashlight, a headlamp, a lantern, a nightlight, and a top light. The portable lighting device 100 includes a light source 104, a switch 105, a brightness control element 106, a display 107, a contact 108 for receiving power, and a light source controller 109. The portable lighting device 100 includes any lighting device having the light source 104 and receives power through contact 108. For example, the light source 104 may be connected to batteries through contact 108. Alternately, light source 104 may be connected to an external power source through contact 108.

Light source 104 is illuminated by switch 105 being switched to a first position at which the light source controller 109 supplies power to light source 104 from power received through contact 108. Once power is on, the brightness control element 106 may be used to adjust the brightness intensity of the light source 104 upwards or downwards to a desired brightness intensity level. As described in greater detail below, the brightness control element 106 may be a rotating ring, a slide switch, a +/− switch, a thumbwheel, a capacitive pad, a rotary switch, a dial, a potentiometer, a voice activated element, a photosensitive element, or a timer activated element.

For explanatory purposes and sake of brevity, the device 100 is described in connection with a flashlight. FIG. 2 shows a side view of an embodiment of the portable lighting device 100 of FIG. 1 such as a flashlight. In the embodiment shown, the device 100 includes a hollow tubular body 101, a reflector assembly 102 connected at a first end of the tubular body 101, an end cap 103 connected at a second end of the tubular body 101, a light source 104 disposed within reflector assembly 102, a switch 105, a brightness control element 106, a display element 107 and the contact 108. The light source 104 may be an incandescent lamp, one or more light emitting diodes, fluorescent light, or other light sources that are controlled by a light source controller 109 which may be disposed within the hollow interior of tubular body 101. The light source 104, switch 105, brightness control element 106, display element 107, contact 108 and light source controller 109 are operatively interconnected as discussed in detail below (see also FIG. 6).

The source of the power received through contact 108 includes a set of primary batteries, a set of secondary batteries, a battery pack, or an electrochemical capacitor known as a supercapacitor or ultracapacitor. The end cap 103 may be removed for allowing the power source to be removed and replaced as required. The batteries may include batteries of different sizes and chemistry. For example, the battery sizes include “AA”, “AAA”, “C”, “D”, “9-Volt”, or lantern sized batteries. The chemistry of the batteries include zinc-carbon, alkaline, lithium, nickel-cadmium (NiCD), and nickel-metal hydride (NiMH).

For some portable lighting devices 100 that are not flashlights, the power source may be external to the device 100 and provided through contact 108 through a wire or induction. The external power source may include sources of direct current such as 12 volt direct current from an automobile's electrical system or alternating current such as 120 v.a.c. from a mains line such as a conventional source like a household outlet.

In the illustrated embodiment, the brightness control element 106 may include a ring that is disposed about tubular body 101 adjacent to the end at which the reflector assembly 102 is affixed. The ring 106 is rotatable about an axis of tubular body 101 through a range of rotation in a first direction denoted by arrow P and a second direction denoted by arrow N. The ring 106 is rotated in the first direction P up to a maximum rotated position to increase the brightness intensity level of light source 104 to the highest setting. The ring 106 is rotated in the second direction N up to a maximum rotated position to decrease the brightness intensity level to the lowest setting. The ring 106 may be operatively connected to a first switch (not shown) which is closed when the ring 106 is rotated in the P direction. The first switch is operatively connected to light source controller 109 which increases the brightness intensity level of light source 104 until the ring 106 is released. The ring 106 may be additionally or alternately operatively connected to a second switch (not shown) which is closed when ring 106 is rotated in the N direction. The second switch is operatively connected to light source controller 109 which decreases the brightness intensity level of light source 104 until the ring 106 is released.

The ring 106 may be spring biased in both the P and N directions so that the ring 106 returns to a normal or default position when released. The ring 106 may be made of rubber or other material that is easy to grasp and gives the user feedback such as a tactile sensation when the ring 106 is urged in either of the P or N directions. The ring 106 may additionally or alternately include other feedback mechanisms such as detents which click or otherwise make a sound to indicate when the ring 106 is rotated into the P and N maximum rotated positions and the normal position. An audible indicator may be a speaker (not shown) connected to the light source controller 109.

The light source controller 109 may include a microprocessor using pulse width modulation (PWM), pulse frequency modulation (PFM), or other techniques to control the amount of power supplied to the light source 104 when the ring 106 is rotated in either the P or N directions. If the light source 104 includes multiple light emitting diodes, the light source controller 109 may control the brightness intensity level by turning the power on and off to a predetermined number of light emitting diodes corresponding to a desired brightness intensity level.

The microprocessor 109 may include a timer that shuts off the power after a predetermined time to prolong the life of the power source. The microprocessor 109 may include a memory which stores the current brightness level when the switch 105 is turned off so that when the switch 105 is turned on again, the light source 104 is illuminated at the brightness intensity level stored in the memory. This eliminates the need for the user to adjust the device 100 to a desirable brightness intensity level each time the device 100 is switched on.

The display element 107 may be a liquid crystal display (LCD), seven segment display, LED, plasma, flat panel, or other display that displays information such as one or more usage parameters like brightness intensity level, lumen output, power consumption, and amount of time and/or remaining power available at the current brightness setting. With this information, the user may adjust the current power setting to extend the amount of time that light is available.

To turn off the light source 104, the switch 105 is moved in the second direction which causes light source controller 109 to disconnect the power from light source 104. In another embodiment of the invention, switch 105 is eliminated and the ring 106 is used to indicate to light source controller 109 when to turn the power on and off to light source 104. For example, when the ring 106 is rotated in the P direction up to the maximum rotated position and held for a predetermined time, the light source controller 109 may switch the power on to the light source 104. The ring 106 may be held for an additional amount of time until the desired brightness intensity level is achieved. Oppositely, when ring 106 is moved in N direction and held for a predetermined time, light source controller 109 may switch the power off to light source 104.

In an embodiment of the invention, the light source controller 109 may include a wireless interface (not shown) allowing the brightness control element to be remotely controlled with a remote device (not shown) such as a wireless device including RF and infrared devices. The remote device may include a display for displaying information such as one or more usage parameters like brightness intensity level, lumen output, power consumption, and amount of time and/or remaining power available at the current brightness setting. With this information, the user may adjust the power setting to extend the amount of time that light is available with the remote device.

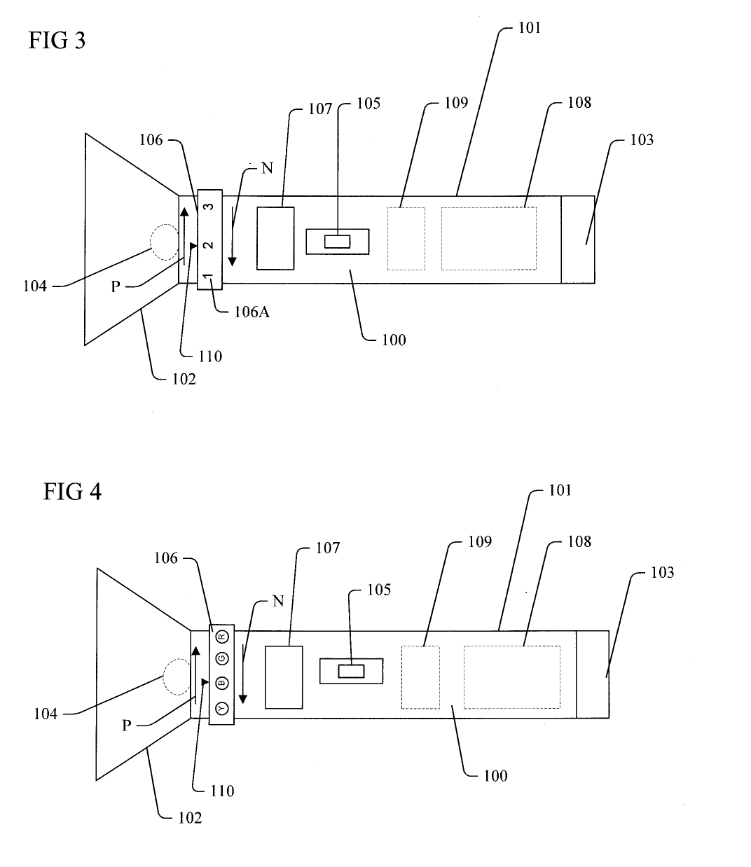

Referring now to FIG. 3, shown is a side view of an embodiment of a portable lighting device 100 similar to the flashlight shown in FIG. 2. For explanation purposes and the sake of brevity, only the portions of the flashlight shown in FIG. 3 that differ from the flashlight of FIG. 2 are discussed below.

The light source 104 is illuminated by switch 105 being switched to a first position at which the light source controller 109 supplies power to the light source 104. Once power is on, the brightness control element 106 may be moved by the user to adjust the brightness intensity level of the light source 104 upwards or downwards through a plurality of fixed intensity levels to a desired brightness intensity level. The fixed intensity levels may be default settings defined by the manufacturer or defined by the user based upon one or more usage parameters like brightness intensity level, lumen output, power consumption, and amount of time and/or power available at the power source. Alternately, the brightness control element 106 may be moved to a desired brightness intensity level before the switch 105 is moved to the first position to cause light source controller 109 to switch the power on to the light source 104. This allows the brightness intensity level to be preselected before the device 100 is turned on and will remain at that brightness intensity level for all subsequent use until changed.

The brightness control element 106 may be a ring that is disposed about tubular body 101 adjacent to reflector assembly 102. The ring 106 is rotated about an axis of the tubular body 101 through a range of one or more predetermined positions Pᵢ circumferentially spaced about ring 106 and denoted with indicia such as numerals 1, 2, 3 . . . (shown), A,B,C . . . , I, II, III . . . , denoting the highest to the lowest brightness intensity level positions. Each of the predetermined positions Pᵢ may be a predetermined percentage of the total intensity or lumen output of the light source 104, e.g., 100%, 90%, . . . 10%, etc. The relationship of the lumen output between each of the predetermined positions Pᵢ may be linear or logarithmic, with the logarithmic relationship being preferred since the human eye perceives changes in lumen output logarithmically. For example, the predetermined positions Pᵢ may include 40 or more dB (0% lumen output), 10 dB (10% lumen output), 6 db (25% lumen output), 3 dB (50% lumen output), 1.2 db (75% lumen output), and 0 dB (100% lumen output).

The indicia 1, 2 and 3 serve as visual indicators of the position of the ring 106 with respect to an indicator 110 on the tubular body 101 adjacent the ring 106. Positions 1, 2 and 3 are shown on ring 106 in FIG. 3, although there may be more predetermined positions Pᵢ where i is the maximum number of positions that may be disposed on the ring 106. Each of the predetermined positions Pᵢ such as positions 1, 2 and 3 correspond to a predetermined brightness intensity level that the user may select by rotating the ring 106 and aligning the predetermined positions 1, 2 and 3 with the indicator 110.

Each of the predetermined positions Pᵢ such as positions 1, 2 and 3 may have a corresponding detent arrangement built into the ring 106 which temporarily locks the ring 106 into the position Pᵢ while giving the user a tactile sensation that the ring 106 has been moved into that particular predetermined position Pᵢ. Each predetermined position Pᵢ may include an audible indicator to indicate when the ring 106 has been moved into that particular predetermined position Pᵢ. Such audible indicators include a mechanical “click” when the ring 106 rotates into the respective detent or a tone generated by the light source controller 109 and an associated speaker (not shown).

The light source controller 109 may be a potentiometer which is mechanically coupled to ring 106 to control the amount of power supplied to the light source 104 when ring 106 is rotated through the predetermined positions Pᵢ such as positions 1, 2 and 3 in either the P or N directions.

In another embodiment of the invention, the light source controller 109 may be a series of shunt resistors each having a predetermined value that correspond to each of the predetermined positions Pᵢ such as positions 1, 2 and 3 for allowing a predetermined amount of power to be supplied to the light source 104 corresponding to a predetermined brightness intensity level.

In another embodiment of the invention, the light source controller 109 may be a microprocessor that uses sensors such as hall effect sensors to sense the position of the ring 106 and control the power supplied to the light source 104 using PWM, FPM, or other techniques. The microprocessor may include a timer that shuts the power off after a predetermined time to prolong the life of the power source.

In another embodiment of the invention, the device 100 may include a third switch (not shown) which is used to adjust the brightness intensity level of the light source 104 to a brightness intensity level that is not available at one of the predetermined positions of the brightness control element 106. For example, the third switch may be connected to the light source controller 109 and used to control the power supplied to the light source 104 to adjust the brightness intensity level to a level between the brightness intensity levels of the predetermined positions denoted as 1 and 2 in FIG. 3. Thus, the third switch allows for an infinite number of positions of the brightness control element 106 and brightness intensity levels.

To turn off the light source 104, the switch 105 is moved in a second direction which causes the light source controller 109 to remove power supplied to the light source 104. In another embodiment of the invention, the switch 105 is eliminated and the ring 106 is used to indicate to the light source controller 109 when to switch the power on and off to the light source 104. For example, the ring 106 may be rotated to one of the predetermined positions 1, 2 and 3 which corresponds to the light source 104 not being illuminated.

Referring now to FIG. 4, shown is a side view of an embodiment of a portable lighting device 100 similar to the flashlight shown in FIG. 3. For explanation purposes and the sake of brevity, only the portions of the flashlight shown in FIG. 4 that differ from the flashlight of FIG. 3 are discussed below.

In the illustrated embodiment, the ring 106 includes visual indicators such as R, G, B and Y. The visual indicators R, G, B and Y may be colored lights such as light emitting diodes which are illuminated when the respective light is aligned with the indicator 110 to indicate a predetermined brightness intensity level associated with the corresponding position Pᵢ of the ring 106. For example, the visual indicators may be red, green, blue and yellow light emitting diodes which indicate a predetermined brightness intensity level associated with the corresponding position Pᵢ of the ring 106. This enables the user to see the position Pᵢ of the ring 106 which may not be otherwise visible in the dark.

In another embodiment of the invention, the light source 104 may be multiple light sources each of a different color and each of the predetermined positions Pᵢ of the ring 106 corresponds to a specific color. Thus, when the ring 106 is rotated, a different colored light source 104 is illuminated along with the corresponding identically colored lighted visual indicator, e.g., R, G, B or Y disposed on the ring 106. This allows selection of a predetermined color of light to be illuminated before the device 100 is switched on and the color of the light will stay the same until the ring 106 is rotated to another predetermined position Pᵢ. Alternately, the light source 104 may be multiple light sources each of a different type such as l.e.d., infrared, and ultraviolet light. When ring 106 is rotated, a different type of light source 104 is illuminated along with a corresponding lighted visual indicator disposed on the ring 106 indicating the type of light source illuminated.

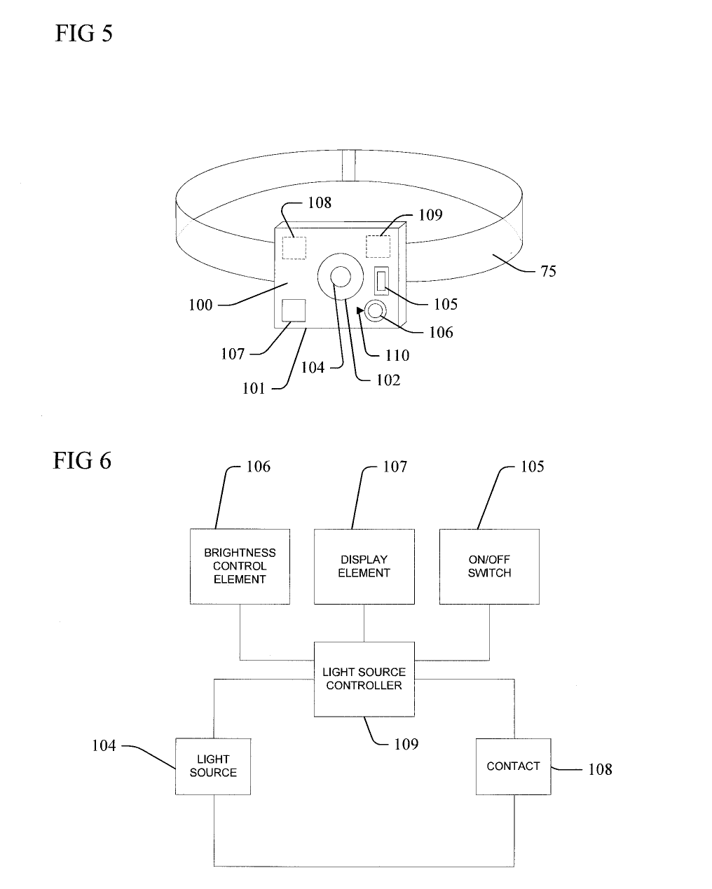

Referring now to FIG. 5, shown is a perspective view of an embodiment of the portable lighting device 100 of FIG. 1 mounted on an adjustable band 75 for use as a headlamp. The embodiment of the lighting device 100 shown is similar to the embodiments of the lighting device 100 shown in FIGS. 2-4 with the main difference being the body 101 being rectangular in shape and being mounted on the adjustable band 75. The adjustable band 75 is used for mounting the lighting device 100 on the head of the user.

In the illustrated embodiment, the lighting device 100 may include any of the features described for the embodiments of the lighting device 100 of FIGS. 2-4. Particularly, the lighting device 100 includes a body 101, a reflector assembly 102 mounted on the body 101, a light source 104 disposed within the reflector assembly 102, a switch 105, a brightness control element 106, a display element 107, a contact 108 for receiving power, a light source controller 109, and an indicator 110.

Referring now to FIG. 6, shown is a block diagram of a circuit for use with the embodiments of the device 100 of FIGS. 1-5. The circuit includes the contact 108 for receiving power interconnected with the lighting source controller 109. The light source controller 109 is interconnected to the light source 104 and controls the power to the light source 104. The light source controller 109 may receive one or more inputs from an on/off switch 105 and/or a brightness control element 106 for controlling the power and the amount of power supplied to light source 104. Thus, the light source controller 109 controls the brightness intensity level of the light source 104 based upon inputs from brightness control element 106 and/or on/off switch 105.

The light source controller 109 provides an output to a display element 107 which displays one or more usage parameters of the device 100 related to the light source 104 and power source such as brightness intensity level, lumen output, power consumption, and amount of time and/or power available at the current brightness setting.

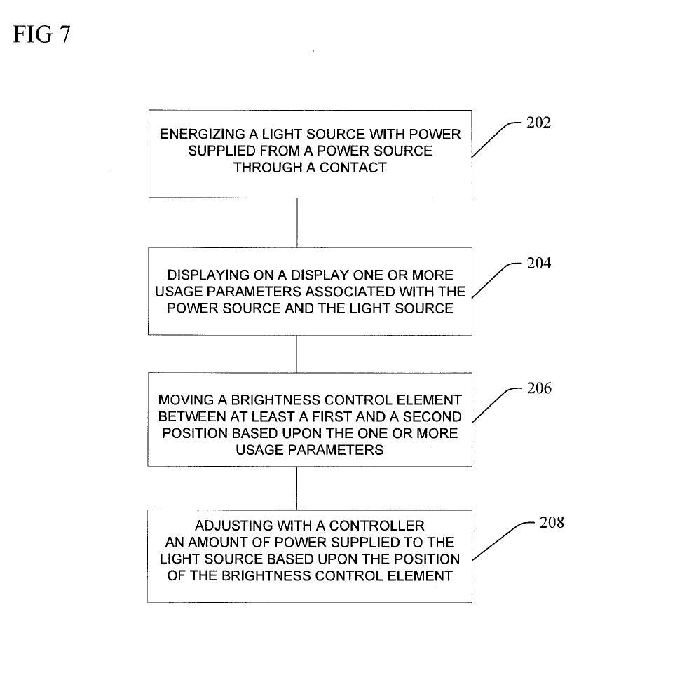

Referring now to FIG. 7, shown is a flow diagram of a method of use of the embodiments of the portable lighting device of FIGS. 1-5. In 202, a light source is energized with power supplied from a power source through the contact. In 204, one or more usage parameters associated with the power source and the light source are displayed on a display. In 206, a brightness control element is moved between at least a first position and a second position based upon the one or more usage parameters displayed on the display. In 208, an amount of power supplied by the power source to the light source is adjusted with a controller in electrical communication with the brightness control element based on the position of the brightness control element.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

I claim:

1. A lighting device, comprising:
a light source,
a body supporting the light source;
a contact for receiving power for energizing the light source;
a brightness control element movable between at least a first position and a second position;
a controller in electrical communication with the brightness control element and configured to adjust an amount of power supplied to the light source based on the position of the brightness control element; and
a display operatively connected to the controller for displaying one or more usage parameters associated with the power source and the light source.

2. The device of claim 1, wherein the brightness control element (106) includes a ring which rotates between the first and second positions.

3. The device of claim 2, wherein the first position is a maximum rotation of the brightness control element in a first direction and the second position is a maximum rotation of the brightness control element in a second direction.

4. The device of claim 3, wherein the brightness control element is rotated in the first direction to increase the brightness level.

5. The device of claim 3, wherein the brightness control element is rotated in the second direction to decrease the brightness level.

6. The device of claim 1, wherein the brightness control element is movable from a default position between the first and second positions to the first and second positions, and the brightness control element is biased towards the default position from the first and second positions.

7. The device of claim 1, wherein the controller includes a timer for switching off the power supplied to the light source after a predetermined time.

8. The device of claim 1, wherein the one or more usage parameters include brightness intensity level, lumen output, power consumption, and amount of time and/or power available at the current brightness level setting.

9. The device of claim 1, wherein the light source includes an incandescent lamp, a fluorescent light, one or more light emitting diodes, and multiple light sources each of a different color.

10. The device of claim 1, wherein the brightness control element is positioned between multiple predetermined fixed positions of the brightness control element.

11. The device of claim 10, wherein the predetermined fixed positions are defined according to the one or more usage parameters associated with the power source and the light source.

12. The device of claim 10, wherein the predetermined fixed positions are defined prior to the light source being energized.

13. The device of claim 10, wherein the predetermined fixed positions are a left position, a middle position, and a right position.

14. The device of claim 10, wherein the brightness control element energizes the light source when positioned between the predetermined fixed positions of the brightness control element.

15. The device of claim 10, wherein the predetermined fixed positions are labeled with indicia corresponding to a brightness level.

16. The device of claim 15, further comprising an indicator disposed on the body which aligns with the indicia of the corresponding predetermined fixed positions as the brightness control element is moved through each of the predetermined fixed positions.

17. The device of claim 16, further comprising a detent associated with the indicator configured to lock the brightness control element when the brightness control element is moved into one of the predetermined fixed positions and produce an audible and tactile indicia.

18. The device of claim 15, wherein the indicia associated with each of the predetermined fixed positions is a lighted visual indicator of a different color, wherein each color corresponds to the brightness level corresponding to the predetermined fixed position.

19. The device of claim 1, wherein the brightness control element is one of a slide switch, a +/− switch, a thumbwheel, a capacitive pad, a rotary switch, a dial, a potentiometer, a voice activated element, a photosensitive element, or a timer activated element.

20. The device of claim 1, further comprising a wireless interface operatively connected to the controller configured to remotely adjust an amount of power supplied to the light source.
